(19) United States
(12) Patent Application Publication
(10) Pub. No.: US 2025/0143341 A1
(43) Pub. Date: May 8, 2025

(54) READY TO MIX GREEN COFFEE AND METHOD OF PROCESSING THEREOF

(71) Applicant: LN LABORATORIES PVT LTD, Hyderabad (IN)

(72) Inventors: Prasad R.G.S.V., Hyderabad (IN); Venkatanarayana KURELLA, Hyderabad (IN)

(21) Appl. No.: 18/835,041

(22) PCT Filed: Apr. 3, 2023
(86) PCT No.: PCT/IB2023/050868

§ 371 Date: Aug. 1, 2024

(30) Foreign Application Priority Data
Feb. 1, 2022 (IN) 202241005399

(51) Int. Cl. A23F 5/40; A23F 5/24; A23F 5/28; A23F 5/42; A23F 5/46

(52) U.S. Cl. CPC A23F 5/40; A23F 5/243; A23F 5/285; A23F 5/42; A23F 5/46

(57) ABSTRACT

The present invention relates to a composition of a ready to mix drink with green coffee extract as the main component. The current embodiment of our present invention includes three types of composition to provide flavour difference. Namely, mocha coffee, roasted coffee and cappuccino coffee flavour. The main components of the composition include the following ingredients in all the variants namely green coffee extract (50%), pullulan, propylene glycol, maltodextrin, polyethylene oxide, glycerol, polysorbate 80, sorbitol, nuesilin UFL2. Di basic calcium phosphate anhydrous, with only the flavoring agent as the changeable component to the composition.

### FIELD OF INVENTION

The present invention relates to the field of ready-to-mix/eat food industry. More specifically it relates to the composition of a ready-to-mix beverage mix with green coffee extract as the primary ingredient.

### BACKGROUND OF THE INVENTION

Modern lifestyle has proven to be one of the main causes of many minors to chronic diseases recently by renowned organizations. This lifestyle can be characterized by the sedentary working practice, untimely and unhealthy diet choices and insufficient sleep cycle. Most common diseases or disorders that follow the above-mentioned practices are accumulation of toxins, unhealthy blood sugar levels, irregular blood pressure, stressful mental health, weight gain, early aging and so on.

In order to revamp or stabilize the health, multiple diet and lifestyle changes has been brought in successfully practiced all over the world. One of those practices is the introduction of green coffee in the diet. Green coffee provides abundant health benefits when included as a part of regular diet. It helps in regulating blood pressure, regulating blood sugar, managing body weight, enhances mood and so on.

Coffee is one of the most popular and frequently consumed drinks. The common form of preparing include dissolving a soluble form in boiling water, and ground or roasted coffee are used unlike the present invention. To make it more feasible and efficient the dietary intake of green coffee has been packaged in certain way that just supplies the required quantity under product recommendations. The consumption of green coffee has been introduced in many different ways like capsules, instant, mix, readymade drink, dipping sachets and the like.

In a patent JP6557882B2 relates to a method for producing a capsule comprising coffee oil, the method providing one or more aqueous compositions comprising a coffee extract and a composition comprising coffee oil optionally emulsifying said composition comprising coffee oil in an aqueous phase to provide an oil-in-water emulsion, mixing a first aqueous composition comprising a coffee extract at a pH of less than 7 with the composition comprising coffee oil, thereby providing an oil-in-water emulsion.

Similarly, in another patent ES2441564T3 relates to a process for producing a coffee mixture and to the coffee mixture obtained by this procedure, wherein the coffee mixture is characterized in that a coffee beverage made from said coffee mixture contains large amounts of acids. Chlorogenic (CGA) and N-methylpyridinium (NMP) cations and optionally, low amounts of 5-hydroxytrypamides of carboxylic acid (C5-HT) and has a higher antioxidant activity

People take green coffee for obesity, diabetes, high blood pressure, high cholesterol, and many other conditions. Green coffee bean extract is composed of chlorogenic acids that hold antioxidant properties and are great free radical eliminators. This promotes the regeneration of new skin cells, concealing fine lines and wrinkles. Green coffee beans are full of essential nutrients and antioxidants that help combat free radicals damage in the body. Free radicals are known to increase the risk of cancer and other chronic diseases. Studies have also disclosed that chlorogenic acid in given coffee beans prevents the formation of tumour cells and the risk of certain types of cancer.

Being inherently rich in antioxidants. green coffee bean is a restorative beverage that enhances psychomotor and cognitive performance and prevents Alzheimer's disease. The richness of caffeine increases the release of dopamine, the brain messengers that are believed to uplift mood, attention, alertness, and brain function. Green coffee bean acts as a natural detoxifier and helps to flush out toxins. impurities, excess fat, and cholesterol from the system. Having this energizing beverage supports bolsters the immune system and optimizes overall health and well-being.

There are several other existing processes and methods providing different aspects of enhancements in consumption of green coffee. However, there still exists a need to develop a variation in order to make it easy to use and flavorful to consume.

### Objective of the Present Invention

The primary objective of the present invention is to develop a composition of a ready to mix drink with green coffee extract as the main component.

The other objective of our present invention is to includes different types of flavour, namely, mocha coffee, roasted coffee and cappuccino coffee flavour.

Another objective of the present invention is to provide a ready-to-mix beverage composition promoting green coffee similar to green tea, wherein now coffee lovers can indulge in their love of coffee with the added health benefits of green coffee.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing and the claims and the abstract, as a whole.

The present invention relates to a ready to mix beverage composition with green coffee extract as the main component in film form.

In one aspect of the present invention, the composition is provided for 150 mg in net weight and includes three types of flavour components, namely, mocha coffee, roasted coffee and cappuccino coffee flavour.

In another aspect of the present invention, the composition includes same ingredients in all the variants namely green coffee extract (50%), pullulan, propylene glycol, maltodextrin, polyethylene oxide, glycerol, polysorbate 80, sorbitol, nuesilin UFL2. Di basic calcium phosphate anhydrous.

In yet another aspect of the present invention, the flavoring agents are the only component that differs in the ingredient list of the composition, each variant has its respective flavors namely mocha coffee, roasted coffee and cappuccino coffee flavour, in solid and liquid form as desired.

The present invention relates to a composition of a ready-to-mix disintegrating beverage strips with green coffee extract as the main component. The beverage strips disintegrate in hot water and does not retain any residual matter.

In yet another aspect of the present invention, all the ingredients are processed in heat in a particular order and the wet slurry is subjected to vacuum degassing.

Coating of the said wet slurry at process parameters of Coating Thickness 900-1150μ, Drying Temperature −9±3° C., Drying Time—23 minutes and Drying at Indirect heating mode. Post drying, slit the film into 30 mm×40 mm (width×Length) to get the desired weight.

### BRIEF DESCRIPTION OF THE DRAWINGS

The manner in which the present invention is formulated is given a mom particular description below, briefly summarized above, may be had by reference to the components, some of which is illustrated in the appended drawing It is to be noted; however, that the appended drawing illustrates only typical embodiments of this invention and are therefore should not be considered limiting of its scope, for the system may admit to other equally effective embodiments.

Throughout the drawings, the same drawing reference numerals will be understood to refer to the same elements and features.

The features and advantages of the present invention will become more apparent from the following detailed description a long with the accompanying figures, which forms a part of this application and in which:

FIG. 1: Block Diagram depicting the manufacturing process of the ready-to-mix green coffee beverage composition, in accordance with our present invention;

### REFERENCE NUMERALS

100—weighed quantity of water in as container
100(a)—stirred at 350 RPM
101—weighed quantity of green coffee extract added
101(a)—stirring at 350 RPM for 5 minutes
102—weighed quantity of pullulan added
102(a)—stirring at 350 RPM for 5 minutes
103—weighed quantity of maltodextrin added
103(a)—stirring at 500 RPM for 5 minutes
104—weighed quantity of polyethylene oxide added
104(a)—stirring at 500 RPM for 10 minutes
105—weighed quantity of solid flavour added
105(a)—stirring at 500 RPM for 5 minutes
106—weighed quantity of Di basic calcium phosphate anhydrous added
106(a)—stirring at 500 RPM for 2 minutes
107—weighed quantity of Magnesium Aluminometasilicate (MAS) added
107(a)—stirring at 500 RPM for 2 minutes
108—weighed quantity of propylene glycol added
108(a)—stirring at 500 RPM for 5 minutes
109—weighed quantity of polysorbate-80 added
109(a)—stirring at 500 RPM for 5 minutes
110—weighed quantity of sorbitol added
110(a)—stirring at 500 RPM for 5 minutes
111—weighed quantity of glycerol added
   111(a)—stirring at 500 RPM for 5 minutes
   112—weighed quantity of liquid flavour added
   112(a)—stirring at 500 RPM for 10 minutes
   113—Vacuum degassing. coating, drying, slitting

### DETAILED DESCRIPTION OF THE INVENTION

The principles of operation, design configurations and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention.

The various embodiments outlined in the subsequent sections are constructed such that it provides a complete and a thorough understanding of the disclosed invention, by clearly describing the scope of the invention, for those skilled in the art.

Throughout this specification various indications have been given as to preferred and alternative embodiments of the invention. It should be understood that, it is the appended claims, including all equivalents, which are intended to define the spirit and scope of this invention.

The present invention relates to a composition of a ready-to-mix disintegrating beverage strips with green coffee extract as the main component. The beverage strips disintegrate in hot water and does not retain any residual matter. The composition includes three types of composition to provide flavour difference.

Namely, mocha coffee, roasted coffee and cappuccino coffee flavour. The flavouring agents are the only component that differs in the ingredient list of the composition, each variant has its respective flavours namely mocha coffee, roasted coffee and cappuccino coffee flavour, in liquid form during manufacture.

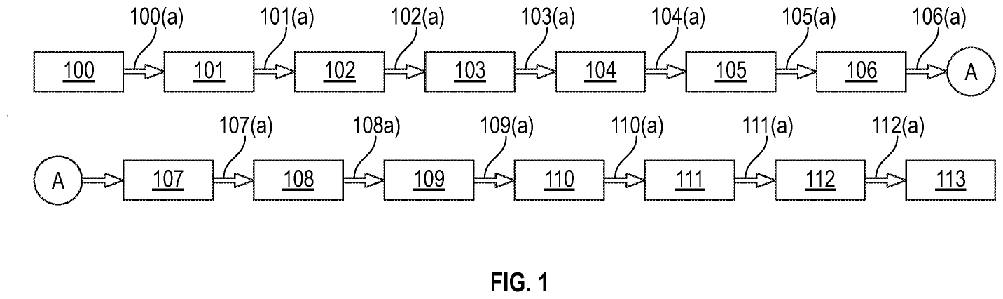

The manufacturing procedure of the current embodiment of our present invention is given below, as shown in FIG. 1:
i. Weighed quantity of purified water (100) in stainless steel container and kept under stirring at 350 RPM (100(a)).
ii. Weighed quantity of green coffee extract (101) was added to step—i under stirring at 350 RPM for 5 minutes (101(a)),
iii. Weighed quantity of Pullulan was added (102) to step-ii under stirring at 350 RPM for 5 minutes (102(a)).
iv. Weighed quantity of maltodextrin (103) was added to step-iii under stirring at 500 RPM for 5 minutes (103(a)).
v. Weighed quantity of Polyethylene oxide (104) to step-iv under stirring at 500 RPM for 10 minutes (104(a)).
vi. Weighed quantity of solid flavour (105) to step-v under stirring at 500 RPM for 5 minutes (105(b)).
vii. Weighed quantity of Di basic calcium phosphate anhydrous (106) to step-vi under stirring at 500 RPM for 2 minutes (106(b)).
viii. Weighed quantity of Magnesium Aluminometasilicate (MAS)(107) to step-vii under stirring at 500 RPM for 2 minutes (107(a)).
ix. Weighed quantity of propylene glycol (108) to step-viii under stirring at 50) RPM for 5 minutes (108(a).
x. Weighed quantity of polysorbate-80 (109) to step-ix under stirring at 500 RPM for 5 minutes (109(a)).
xi. Weighed quantity of Sorbitol (110) to step-x under stirring at 500 RPM for 5 minutes (110ai),
xii. Weighed quantity of Glycerol (111) to step-xi under stirring at 500 RPM for 5 minutes (111(a)).
xiii. Weighed quantity of liquid flavour 4112) to step-xii under stirring at 500 RPM for 10 minutes (112(a)).
xiv. Above step wet slurry subjected to vacuum degassing (113).
xv. Coating of above wet slurry at process parameters of Coating Thickness—900 to 1150μ, Drying Temperature −95±3° C. Drying Time—23 minutes and Drying at Indirect heating mode (113).
xvi. Post drying, slit the film into 30 mm×40 mm (width×Length) to get the desired weight (113).

All the ingredients are, processed in heat in a particular order and the wet slurry is subjected to vacuum degassing. Coating of the said wet slurry at process parameters of Coating Thickness—690μ, Drying Temperature −95±3° C., Drying Time—23 minute and Drying at indirect heating mode. Post drying, slit the film into 10 mm×40 mm (width×Length) to the desired weight.

The ready-to-mix film composition of the different embodiments of our present invention is disclosed in the Table 1, Table 2 and Table 3 below: Table 1:

TABLE 1

| S. No. | Ingredients | Function | % w/w | mg/unit |
|---|---|---|---|---|
| 1 | Green coffee | Active | 35.71 | 150.00 |
| | extract (50%) | | | |
| 2 | Pollulan | Film forming Agent | 35.71 | 150.00 |
| 3 | Maltodextrin | Film forming Agent | 3.52 | 14.77 |
| 4 | Polyethylene oxide | Film forming Agent | 7.14 | 30.00 |
| 5 | Propylene Glycol | Plasticizer | 1.79 | 7.50 |
| 6 | Polysorbate | Plasticizer | 1.79 | 7.50 |
| 7 | Sorbitol | Plasticizer | 1.79 | 7.50 |
| 8 | Glycerol | Plasticizer | 1.79 | 7.50 |
| 9 | Magnesium | Moisture absorbent | 0.05 | 0.23 |
| | Aluminometasilicate | | | |
| | (MAS) | | | |
| 10 | Di basic calcium | Filler | 3.57 | 15.00 |
| | phosphate anhydrous | | | |
| 11 | Mocha coffee | Flavour | 3.57 | 15.00 |
| | Flavour liquid | | | |
| 12 | Mocha coffee | Flavour | 3.57 | 15.00 |
| | Flavour solid | | | |
| 13 | Purified Water* | Vehicle | q.s. | q.s. |

| | | |
|---|---|---|
| Total | 100.00 | 420.00 |

*water get evaporated during the coating prosses and traces of water content will remain in product.

TABLE 2

| S. No. | Ingredients | Function | % w/w | mg/unit |
|---|---|---|---|---|
| 1 | Green coffee extract (50%) | Active | 35.71 | 150.00 |
| 2 | Pullulan | Film | 35.71 | 150.00 |
| | | forming | | |
| | | Agent | | |
| 3 | Maltodextrin | Film | 3.52 | 14.77 |
| | | forming | | |
| | | Agent | | |
| 4 | Polyethylene oxide | Film | 7.14 | 30.00 |
| | | forming | | |
| | | Agent | | |
| 5 | Propylene Glycol | Plasticizer | 1.79 | 7.50 |
| 6 | Polysorbate | Plasticizer | 1.79 | 7.50 |
| 7 | Sorbitol | Plasticizer | 1.79 | 7.50 |
| 8 | Glycerol | Plasticizer | 1.79 | 7.50 |
| 9 | Magnesium | Moisture | 0.05 | 0.23 |
| | Aluminometasilicate (MAS) | absorbent | | |
| 10 | Di basic calcium | Filler | 3.57 | 15.00 |
| | phosphate anhydrous | | | |
| 11 | Roasted coffee flavour (Liquid) | Flavour | 3.57 | 15.00 |
| 12 | Roasted coffee flavour (solid) | Flavour | 3.57 | 15.00 |
| 13 | Purified Water* | Vehicle | q.s. | q.s. |

| | | |
|---|---|---|
| Total | 100.00 | 420.00 |

*water get evaporated during the coating prosses and traces of water content will remain in product.

TABLE 3

| S. | | | | |
|---|---|---|---|---|
| No. | Ingredients | Function | % w/w | mg/unit |
| 1 | Green coffee extract (50%) | Active | 35.71 | 150.00 |
| 2 | Pullulan | Film | | |
| | | forming | | |
| | | Agent | 3.52 | 14.77 |
| 3 | Maltodextrin | Film | | |
| | | forming | | |
| | | Agent | 7.14 | 30.00 |
| 4 | Polyethylene oxide | Film | | |
| | | forming | | |
| | | Agent | 1.79 | 7.50 |
| 5 | Propylene Glycol | Plasticizer | 1.79 | 7.50 |
| 6 | Polysorbate | Plasticizer | 1.79 | 7.50 |
| 7 | Sorbitol | Plasticizer | 1.79 | 7.50 |
| 8 | Glycerol | Plasticizer | 0.05 | 0.23 |
| 9 | Magnesium | Moisture | | |
| | Aluminometasilicate (MAS) | absorbent | 3.57 | 15.00 |
| 10 | Di basic calcium | Filler | | |
| | phosphate anhydrous | | | |
| 11 | Cappuccino coffee flavour (Liquid) | Flavour | 3.57 | 15.00 |
| 12 | Cappuccino coffee flavour (solid) | Flavour | 3.57 | 15.00 |
| 13 | Purified Water* | Vehicle | q.s. | q.s. |

| | | |
|---|---|---|
| Total | 100.00 | 420.00 |

*water get evaporated during the coating prosses and traces of water content will remain in product.

The films were evaluated for disintegration time, folding endurance, water content Assay. The films were subjected to stability study under 40° C.±2° C., and 75%±5% RH condition for six months and evaluated above test parameters and results are tabulated.

Embodiment- 1: Results

| | | | Results | | | |
|---|---|---|---|---|---|---|
| S. | Test | | | 1 | 3 | 6 |
| No. | Parameter | Limits | Initial | month | months | months |
| 1 | Disintegrating | NMT | 57 sec | 58 sec | 48 sec | 48 sec |
| | time | 120 sec | | | | |
| 2 | Folding | NLT 10 | 150 | 150 | 66 | 69 |
| | Endurance | | folds | folds | folds | folds |
| 3 | Water content | NMT 12% | 10.10 | 9.83 | 9.54 | 9.00 |
| 4 | Assay | NLT 80% | 101.4 | 101.5 | 99.7 | 97.5 |
| | (chlorogenic | | | | | |
| | acids) | | | | | |

Embodiment- 2: Results

| | | | Results | | | |
|---|---|---|---|---|---|---|
| S | Test | | | 1 | 3 | 6 |
| No. | Parameter | Limits | Initial | month | months | months |
| 1 | Disintegrating | NMT | 49 sec | 47 sec | 52 sec | 47 sec |
| | time | 120 sec | | | | |
| 2 | Folding | NLT 10 | 150 | 150 | 150 | 150 |
| | Endurance | | folds | folds | folds | folds |
| 3 | Water content | NMT 12% | 9.91 | 7.85 | 9.63 | 7.47 |
| 4 | Assay | NLT 80% | 101.5 | 100.2 | 98.6 | 98.7 |
| | (chlorogenic | | | | | |
| | acids) | | | | | |

Embodimnt- 3: Results

| | | | Results | | | |
|---|---|---|---|---|---|---|
| S. | Test | | | 1 | 3 | 6 |
| No. | Parameters | Limits | Initial | month | months | months |
| 1 | Disintegrating | NMT | 46 sec | 50 sec | 52 sec | 51 sec |
| | time | 120 sec | | | | |
| 2 | Folding | NLT 10 | 150 | 150 | 121 | 106 |
| | Endurance | | folds | folds | folds | folds |
| 3 | Water content | NMT 12% | 9.71 | 7.69 | 8.84 | 8.73 |
| 4 | Assay | NLT 80% | 99.7 | 99.2 | 98.0 | 97.7 |
| | (chlorogenic | | | | | |
| | acids) | | | | | |

In another embodiment of our present invention, the green coffee disintegrating strips can be formulated as instant coffee ground form, without affecting the main composition.

In another embodiment of our present invention, the green coffee disintegrating strips can be formulated with different flavouring agents including vanilla, hazelnut, and other flavours, without affecting the main composition.

Our present invention, the green coffee disintegrating strip completely disintegrates in hot water and won't remain any residual matter. Gives accurate dose as per the label claim. Our present invention, the green coffee disintegrating strip contains chlorogenic acid which gives antioxidant properties. In the current embodiment of our present invention, there is no contact with packing material during green tea preparation and there is no chance of any leachable and extractables. Also there is no loss of nutrients, aroma, essential oils, and flavour in our current embodiment. The current embodiment of our present invention ensures that the above advantages of green coffee are preserved, while presenting the green coffee in an a very palatable manner with no residual bitter dregs while including different flavours that enhance the agreeable taste of the beverage composition of our present invention.

I/We claim:

1. A ready-to-mix disintegrating beverage strip composition comprising;
a. Green coffee extract (50%).
b. Pullulan.
c. Propylene Glycol,
d. Maltodextrin.
e. Polyethylene Oxide.
f. Glycerol,
g. Polysorbate 80,
h. Sorbitol.
i. Nuesilin Uf12,
j. Di Basic Calcium Phosphate Anhydrous and
k. flavouring agent.
Wherein the component (1,j flavouring agent) can vary depending on the flavour selected without affecting the other components of the composition.

2. The ready-to-mix disintegrating beverage strips as claimed in claim 1,
wherein the manufacturing procedure of the ready-to-drink disintegrating beverage strips is given as:
i. Weighed quantity of purified water (100) in stainless steel container and kept under stirring at 350 RPM (100(a).
ii. Weighed quantity of green coffee extract (101) was added to step-i under stirring at 350 RPM for 5 minutes (101(a)).
iii. Weighed quantity of Pullulan was added (102) to step-ii under stirring at 350 RPM for 5 minutes (102(a)).
iv. Weighed quantity of maltodextrin (103) was added to step-iii under stirring at 500 RPM for 5 minutes (103(a)).
v. Weighed quantity of Polyethylene oxide (104) to step-iv under stirring at 50) RPM for 10 minutes (104(a)).
vi. Weighed quantity of solid flavour (105) to step-v under stirring at 500 RPM for 5 minutes (105(b)).
vii. Weighed quantity of Di basic calcium phosphate anhydrous (106) to step-vi under stirring at 500 RPM for 2 minutes (106(b)).
viii. Weighed quantity of Magnesium Aluminumetasilicate (MAS)(107) to step-vii under stirring at 500 RPM for 2 minutes (107(a)).
ix. Weighed quantity of propylene glycol (108) to step-viii under stirring at 500 RPM for 5 minutes (108(a)).
x. Weighed quantity of polysorbate-80 (109) to step-ix under stirring at 500 RPM for 5 minutes (109(a)).
xi. Weighed quantity of Sorbitol. (110) to step-x under stirring at, 500 RPM for 5 minutes (110ai)
xii. Weighed quantity of Glycerol (111) to step-xi under stirring at 500 RPM for 5 minutes (111(a)).
xiii. Weighed quantity of liquid flavour (112) to step-xii under stirring at 500 RPM for 10 minutes (112(a)).
xiv. Above step wet slurry subjected to vacuum degassing (113).
xv. Coating of above wet slurry at process parameters of Coating thickness—900 to 1150μ, Drying Temperature −95±3° C. Drying Time—23 minutes and Drying at Indirect heating mode (113).
xvi. Post drying, slit the film into 30 mm×40 mm (width×Length) to get the desired weight (113).
wherein the said ingredients are processed in heat for 2-5 minutes in the particular order and the wet slurry is subjected to vacuum degassing.

3. The ready-to-mix disintegrating beverage strips as claimed in claim 1, wherein the said ingredients are further subjected to coating of the said wet slurry.

4. The rcady-to-mix disintegrating beverage strips as claimed in claim 1, wherein the said coating process parameters are Coating Thickness—900 to 1150μ, Drying Temperature −95±13° C. Drying Time 23 minutes and Drying at Indirect heating mode.

5. The ready-to-mix disintegrating beverage strips as claimed in claim 1, wherein after post drying, slit the film into 30 mm×40 mm (width×Length) to get the desired weight.

6. The ready-to-mix disintegrating beverage strips as claimed in claim 1, wherein the said beverage strips disintegrate in hot water and does not retain any residual matter.

7. The ready-to-mix disintegrating beverage strips as claimed in claim 1, wherein the beverage strips can be of different flavours including mocha, roasted coffee. cappuccino.
